(19) United States
(12) Patent Application Publication
(10) Pub. No.: US 2022/0198842 A1
(43) Pub. Date: Jun. 23, 2022

(54) PREDICTIVE ANALYTICS FOR VEHICLE HEALTH

(71) Applicant: Motional AD LLC, Boston, MA (US)

(72) Inventors: Shaurya Agarwal, Boston, MA (US); Ayman Alalao, Cambridge, MA (US); Tyler Hendrickson, Tewksbury, MA (US)

(21) Appl. No.: 17/127,959

(22) Filed: Dec. 18, 2020

(51) Int. Cl. G07C 5/08; G07C 5/00

(52) U.S. Cl. CPC G07C 5/0808; G07C 5/006

(57) ABSTRACT

Among other things, techniques are described for predicting the health of vehicle components. The techniques include collecting, using a set of sensors of a vehicle, first sensor data related to a set of events over a period of time, and collecting, using the set of sensors, second sensor data associated with an acute event after the period of time. Using a processor, a health of a component of the vehicle is determined based on the first sensor data and the second sensor data and a correlation between the first and second sensor data and the component of the vehicle. The vehicle is navigated using a control circuit of the vehicle in response to a determination that the health of the component does not meet a predefined threshold.

### FIELD OF THE INVENTION

This description relates to techniques for predicting the health of a vehicle and its components.

### BACKGROUND

A vehicle can include sensors that produce data regarding basic vehicle parameters, such as speed, engine temperature, or mileage. Some vehicles include embedded computers that process this data and output information (e.g., Diagnostic Trouble Codes) to alert drivers of a potential issue with the vehicle.

### BRIEF DESCRIPTION OF THE DRAWINGS

FIG. 1 shows an example of an autonomous vehicle having autonomous capability.

FIG. 2 illustrates an example “cloud” computing environment.

FIG. 3 illustrates a computer system.

FIG. 4 shows an example architecture for an autonomous vehicle.

FIG. 5 shows an example of inputs and outputs that may be used by a perception module.

FIG. 6 shows an example of a LiDAR system.

FIG. 7 shows the LiDAR system in operation.

FIG. 8 shows the operation of the LiDAR system in additional detail.

FIG. 9 shows a block diagram of the relationships between inputs and outputs of a planning module.

FIG. 10 shows a directed graph used in path planning.

FIG. 11 shows a block diagram of the inputs and outputs of a control module.

FIG. 12 shows a block diagram of the inputs, outputs, and components of a controller.

FIG. 13 shows an example of a vehicle in an environment.

FIG. 14 shows a block diagram of the inputs, outputs, and components of a predictive maintenance module.

FIG. 15 shows a block diagram of the operation of a predictive maintenance module.

FIG. 16 shows a flowchart of an example process for predicting maintenance requirements for a vehicle.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:

1. General Overview

2. System Overview

3. Autonomous Vehicle Architecture

4. Autonomous Vehicle Inputs

5. Autonomous Vehicle Planning

6. Autonomous Vehicle Control

7. Predictive Analytics for Vehicle Health

### General Overview

A vehicle (such as an autonomous vehicle) utilizes onboard sensors to collect data about events that affect the operational health of electrical and mechanical components of the vehicle. For example, the vehicle uses onboard microphones and cameras to detect low acuity impacts, such as collisions with road debris or low hanging vegetation, which can cause physical damage to vehicle components. As another example, the vehicle uses cameras and inertial measurement units (IMUs) in conjunction with high definition map data to detect rough terrain (e.g., potholes, unpaved roads, or rapid slope changes) that can increase wear on vehicle components. The events experienced by the vehicle are evaluated using predictive analytics to estimate the health of vehicle components. A maintenance schedule personalized for the vehicle can be generated based on the estimated health of the vehicle components. In an embodiment, the vehicle is navigated (e.g., to a maintenance center) when the estimated health of a vehicle component falls below a particular threshold.

Some of the advantages of these techniques include improved vehicle safety and longevity. For example, by using vehicle sensors to more accurately predict the health of vehicle components, failing components can be repaired proactively to avoid further vehicle damage and increase vehicle safety. In addition, information about the events detected by the vehicle sensors can be used to identify problematic areas of a road network and inform vehicle routing. Further, by using a personalized maintenance schedule for the vehicle, unnecessary maintenance visits are reduced.

### System Overview

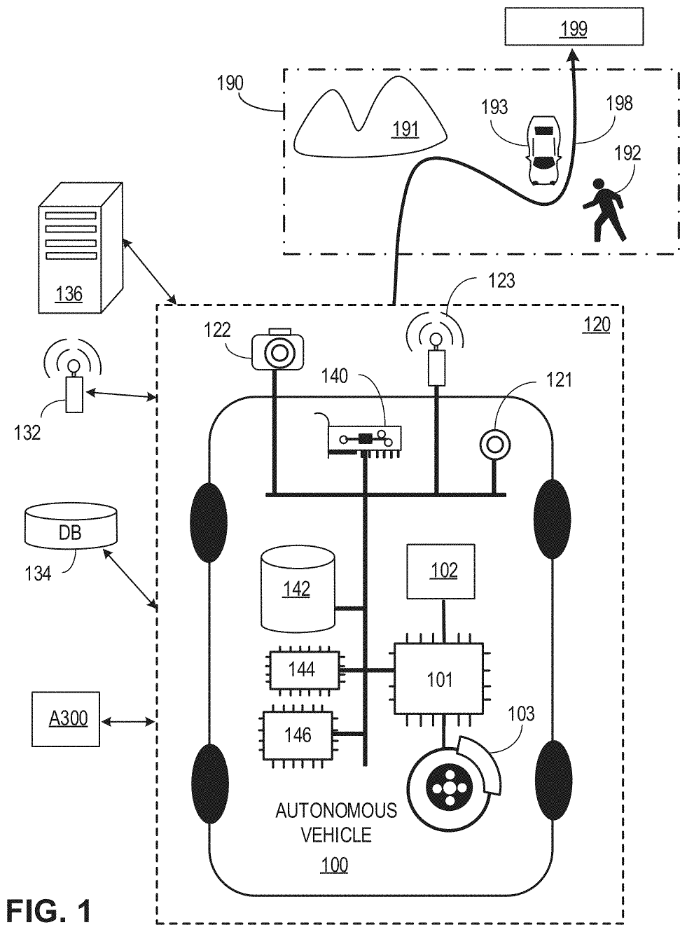

FIG. 1 shows an example of an autonomous vehicle 100 having autonomous capability.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to navigate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle. A lane is sometimes identified based on lane markings. For example, a lane may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings, or having two lanes between the lane markings. A lane could also be interpreted in the absence of lane markings. For example, a lane may be defined based on physical features of an environment, e.g., rocks and trees along a thoroughfare in a rural area or, e.g., natural obstructions to be avoided in an undeveloped area. A lane could also be interpreted independent of lane markings or physical features. For example, a lane could be interpreted based on an arbitrary path free of obstructions in an area that otherwise lacks features that would be interpreted as lane boundaries. In an example scenario, an AV could interpret a lane through an obstruction-free portion of a field or empty lot. In another example scenario, an AV could interpret a lane through a wide (e.g., wide enough for two or more lanes) road that does not have lane markings. In this scenario, the AV could communicate information about the lane to other AVs so that the other AVs can use the same lane information to coordinate path planning among themselves.

The term “over-the-air (OTA) client” includes any AV, or any electronic device (e.g., computer, controller, IoT device, electronic control unit (ECU)) that is embedded in, coupled to, or in communication with an AV.

The term “over-the-air (OTA) update” means any update, change, deletion or addition to software, firmware, data or configuration settings, or any combination thereof, that is delivered to an OTA client using proprietary and/or standardized wireless communications technology, including but not limited to: cellular mobile communications (e.g., 2G, 3G, 4G, 5G), radio wireless area networks (e.g., WiFi) and/or satellite Internet.

The term “edge node” means one or more edge devices coupled to a network that provide a portal for communication with AVs and can communicate with other edge nodes and a cloud based computing platform, for scheduling and delivering OTA updates to OTA clients.

The term “edge device” means a device that implements an edge node and provides a physical wireless access point (AP) into enterprise or service provider (e.g., VERIZON, AT&T) core networks. Examples of edge devices include but are not limited to: computers, controllers, transmitters, routers, routing switches, integrated access devices (IADs), multiplexers, metropolitan area network (MAN) and wide area network (WAN) access devices.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

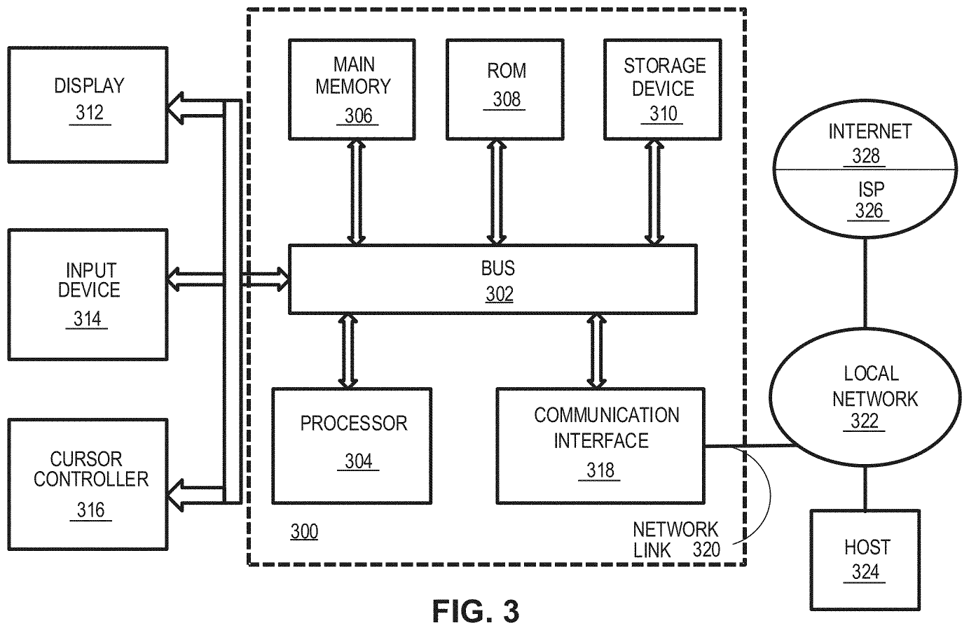

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to cloud computing environment 300 described below with respect to FIG. 3.

In general, this document describes technologies applicable to any vehicles that have one or more autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems may automate certain vehicle operations (e.g., steering, braking, and using maps) under certain operating conditions based on processing of sensor inputs. The technologies described in this document can benefit vehicles in any levels, ranging from fully autonomous vehicles to human-operated vehicles.

Autonomous vehicles have advantages over vehicles that require a human driver. One advantage is safety. For example, in 2016, the United States experienced 6 million automobile accidents, 2.4 million injuries, 40,000 fatalities, and 13 million vehicles in crashes, estimated at a societal cost of $910+ billion. U.S. traffic fatalities per 100 million miles traveled have been reduced from about six to about one from 1965 to 2015, in part due to additional safety measures deployed in vehicles. For example, an additional half second of warning that a crash is about to occur is believed to mitigate 60% of front-to-rear crashes. However, passive safety features (e.g., seat belts, airbags) have likely reached their limit in improving this number. Thus, active safety measures, such as automated control of a vehicle, are the likely next step in improving these statistics. Because human drivers are believed to be responsible for a critical pre-crash event in 95% of crashes, automated driving systems are likely to achieve better safety outcomes, e.g., by reliably recognizing and avoiding critical situations better than humans; making better decisions, obeying traffic laws, and predicting future events better than humans; and reliably controlling a vehicle better than a human.

Referring to FIG. 1, an AV system 120 operates the AV 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

In an embodiment, the AV system 120 includes devices 101 that are instrumented to receive and act on operational commands from the computer processors 146. We use the term “operational command” to mean an executable instruction (or set of instructions) that causes a vehicle to perform an action (e.g., a driving maneuver). Operational commands can, without limitation, including instructions for a vehicle to start moving forward, stop moving forward, start moving backward, stop moving backward, accelerate, decelerate, perform a left turn, and perform a right turn. In an embodiment, computing processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the AV 100, such as the AV's position, linear and angular velocity and acceleration, and heading (e.g., an orientation of the leading end of AV 100). Example of sensors 121 are GPS, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 308 or storage device 310 described below in relation to FIG. 3. In an embodiment, memory 144 is similar to the main memory 306 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the AV 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the AV 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among autonomous vehicles.

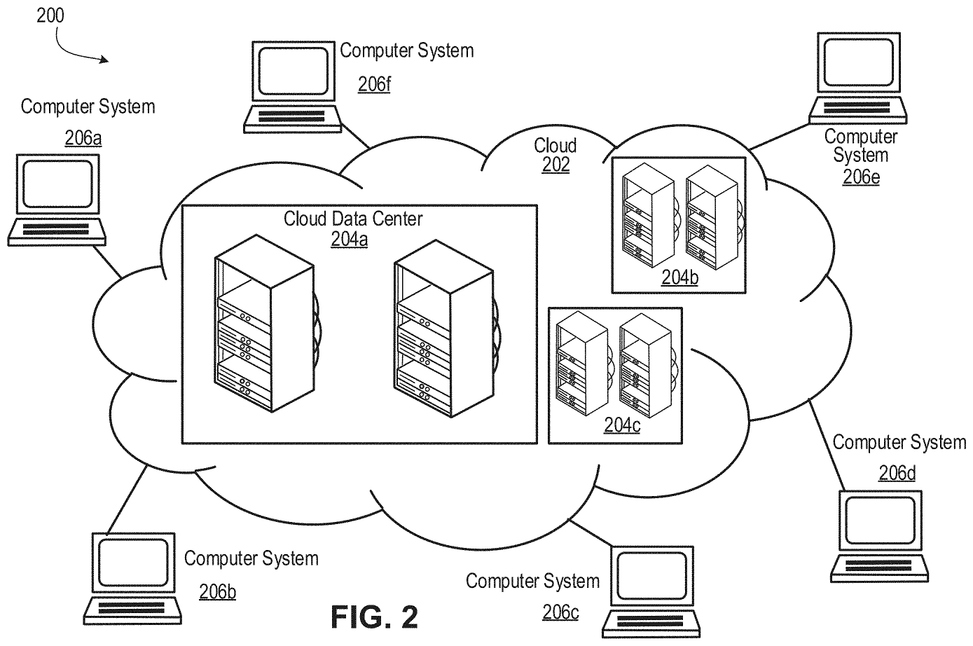

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment 200 as described in FIG. 2. The communication interfaces 140 transmit data collected from sensors 121 or other data related to the operation of AV 100 to the remotely located database 134. In an embodiment, communication interfaces 140 transmit information that relates to teleoperations to the AV 100. In some embodiments, the AV 100 communicates with other remote (e.g., “cloud”) servers 136.

In an embodiment, the remotely located database 134 also stores and transmits digital data (e.g., storing data such as road and street locations). Such data is stored on the memory 144 on the AV 100, or transmitted to the AV 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data may be stored on the memory 144 on the AV 100, or transmitted to the AV 100 via a communications channel from the remotely located database 134.

Computing devices 146 located on the AV 100 algorithmically generate control actions based on both real-time sensor data and prior information, allowing the AV system 120 to execute its autonomous driving capabilities.

In an embodiment, the AV system 120 includes computer peripherals 132 coupled to computing devices 146 for providing information and alerts to, and receiving input from, a user (e.g., an occupant or a remote user) of the AV 100. In an embodiment, peripherals 132 are similar to the display 312, input device 314, and cursor controller 316 discussed below in reference to FIG. 3. The coupling is wireless or wired. Any two or more of the interface devices may be integrated into a single device.

In an embodiment, the AV system 120 receives and enforces a privacy level of a passenger, e.g., specified by the passenger or stored in a profile associated with the passenger. The privacy level of the passenger determines how particular information associated with the passenger (e.g., passenger comfort data, biometric data, etc.) is permitted to be used, stored in the passenger profile, and/or stored on the cloud server 136 and associated with the passenger profile. In an embodiment, the privacy level specifies particular information associated with a passenger that is deleted once the ride is completed. In an embodiment, the privacy level specifies particular information associated with a passenger and identifies one or more entities that are authorized to access the information. Examples of specified entities that are authorized to access information can include other AVs, third party AV systems, or any entity that could potentially access the information.

A privacy level of a passenger can be specified at one or more levels of granularity. In an embodiment, a privacy level identifies specific information to be stored or shared. In an embodiment, the privacy level applies to all the information associated with the passenger such that the passenger can specify that none of her personal information is stored or shared. Specification of the entities that are permitted to access particular information can also be specified at various levels of granularity. Various sets of entities that are permitted to access particular information can include, for example, other AVs, cloud servers 136, specific third party AV systems, etc.

In an embodiment, the AV system 120 or the cloud server 136 determines if certain information associated with a passenger can be accessed by the AV 100 or another entity. For example, a third-party AV system that attempts to access passenger input related to a particular spatiotemporal location must obtain authorization, e.g., from the AV system 120 or the cloud server 136, to access the information associated with the passenger. For example, the AV system 120 uses the passenger's specified privacy level to determine whether the passenger input related to the spatiotemporal location can be presented to the third-party AV system, the AV 100, or to another AV. This enables the passenger's privacy level to specify which other entities are allowed to receive data about the passenger's actions or other data associated with the passenger.

FIG. 2 illustrates an example “cloud” computing environment. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, autonomous vehicles (including, cars, drones, shuttles, trains, buses, etc.) and consumer electronics. In an embodiment, the computing systems 206a-f are implemented in or as a part of other systems.

FIG. 3 illustrates a computer system 300. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 300 includes a bus 302 or other communication mechanism for communicating information, and a hardware processor 304 coupled with a bus 302 for processing information. The hardware processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In an embodiment, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise the bus 302. Transmission media can also take the form of acoustic or light waves, such as those generated during radio-wave and infrared data communications.

In an embodiment, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 may optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic or optical signals that carry digital data streams. The signals through the various networks and the signals on the network link 320 and through the communication interface 318, which carry the digital data to and from the computer system 300, are example forms of transmission media. In an embodiment, the network 320 contains the cloud 202 or a part of the cloud 202 described above.

The computer system 300 sends messages and receives data, including program code, through the network(s), the network link 320, and the communication interface 318. In an embodiment, the computer system 300 receives code for processing. The received code is executed by the processor 304 as it is received, and/or stored in storage device 310, or other non-volatile storage for later execution.

### Autonomous Vehicle Architecture

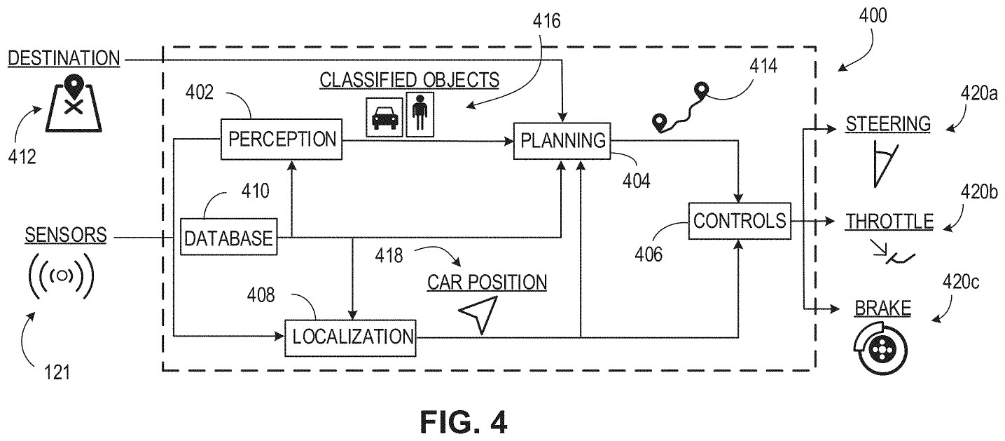

FIG. 4 shows an example architecture 400 for an autonomous vehicle (e.g., the AV 100 shown in FIG. 1). The architecture 400 includes a perception module 402 (sometimes referred to as a perception circuit), a planning module 404 (sometimes referred to as a planning circuit), a control module 406 (sometimes referred to as a control circuit), a localization module 408 (sometimes referred to as a localization circuit), and a database module 410 (sometimes referred to as a database circuit). Each module plays a role in the operation of the AV 100. Together, the modules 402, 404, 406, 408, and 410 may be part of the AV system 120 shown in FIG. 1. In some embodiments, any of the modules 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things). Each of the modules 402, 404, 406, 408, and 410 is sometimes referred to as a processing circuit (e.g., computer hardware, computer software, or a combination of the two). A combination of any or all of the modules 402, 404, 406, 408, and 410 is also an example of a processing circuit.

In use, the planning module 404 receives data representing a destination 412 and determines data representing a trajectory 414 (sometimes referred to as a route) that can be traveled by the AV 100 to reach (e.g., arrive at) the destination 412. In order for the planning module 404 to determine the data representing the trajectory 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 uses data from a GNSS (Global Navigation Satellite System) sensor and geographic data to calculate a longitude and latitude of the AV. In an embodiment, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types. In an embodiment, the high-precision maps are constructed by adding data through automatic or manual annotation to low-precision maps.

The control module 406 receives the data representing the trajectory 414 and the data representing the AV position 418 and operates the control functions 420a-c (e.g., steering, throttling, braking, ignition) of the AV in a manner that will cause the AV 100 to travel the trajectory 414 to the destination 412. For example, if the trajectory 414 includes a left turn, the control module 406 will operate the control functions 420a-c in a manner such that the steering angle of the steering function will cause the AV 100 to turn left and the throttling and braking will cause the AV 100 to pause and wait for passing pedestrians or vehicles before the turn is made.

### Autonomous Vehicle Inputs

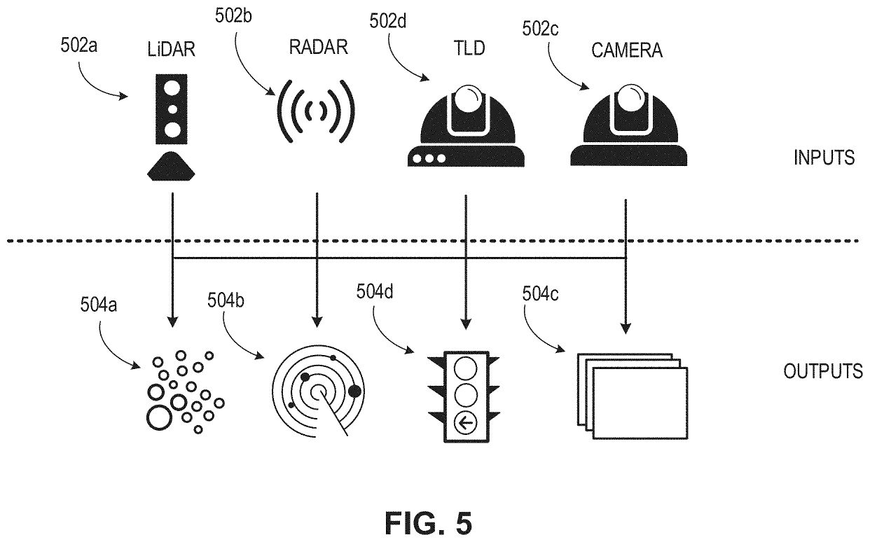

FIG. 5 shows an example of inputs 502a-d (e.g., sensors 121 shown in FIG. 1) and outputs 504a-d (e.g., sensor data) that is used by the perception module 402 (FIG. 4). One input 502a is a LiDAR (Light Detection and Ranging) system (e.g., LiDAR 123 shown in FIG. 1). LiDAR is a technology that uses light (e.g., bursts of light such as infrared light) to obtain data about physical objects in its line of sight. A LiDAR system produces LiDAR data as output 504a. For example, LiDAR data is collections of 3D or 2D points (also known as a point clouds) that are used to construct a representation of the environment 190.

Another input 502b is a RADAR system. RADAR is a technology that uses radio waves to obtain data about nearby physical objects. RADARs can obtain data about objects not within the line of sight of a LiDAR system. A RADAR system 502b produces RADAR data as output 504b. For example, RADAR data are one or more radio frequency electromagnetic signals that are used to construct a representation of the environment 190.

Another input 502c is a camera system. A camera system uses one or more cameras (e.g., digital cameras using a light sensor such as a charge-coupled device [CCD]) to obtain information about nearby physical objects. A camera system produces camera data as output 504c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In use, the camera system may be configured to “see” objects far, e.g., up to a kilometer or more ahead of the AV. Accordingly, the camera system may have features such as sensors and lenses that are optimized for perceiving objects that are far away.

Another input 502d is a traffic light detection (TLD) system. A TLD system uses one or more cameras to obtain information about traffic lights, street signs, and other physical objects that provide visual navigation information. A TLD system produces TLD data as output 504d. TLD data often takes the form of image data (e.g., data in an image data format such as RAW, JPEG, PNG, etc.). A TLD system differs from a system incorporating a camera in that a TLD system uses a camera with a wide field of view (e.g., using a wide-angle lens or a fish-eye lens) in order to obtain information about as many physical objects providing visual navigation information as possible, so that the AV 100 has access to all relevant navigation information provided by these objects. For example, the viewing angle of the TLD system may be about 120 degrees or more.

In some embodiments, outputs 504a-d are combined using a sensor fusion technique. Thus, either the individual outputs 504a-d are provided to other systems of the AV 100 (e.g., provided to a planning module 404 as shown in FIG. 4), or the combined output can be provided to the other systems, either in the form of a single combined output or multiple combined outputs of the same type (e.g., using the same combination technique or combining the same outputs or both) or different types (e.g., using different respective combination techniques or combining different respective outputs or both). In some embodiments, an early fusion technique is used. An early fusion technique is characterized by combining outputs before one or more data processing steps are applied to the combined output. In some embodiments, a late fusion technique is used. A late fusion technique is characterized by combining outputs after one or more data processing steps are applied to the individual outputs.

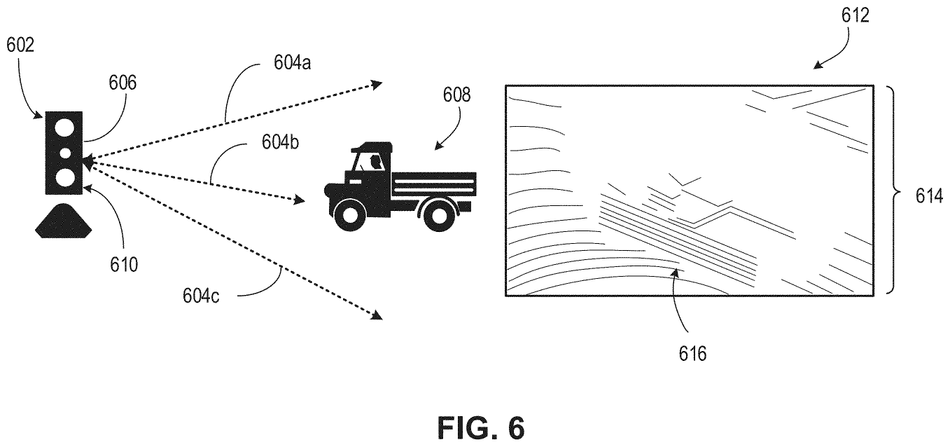

FIG. 6 shows an example of a LiDAR system 602 (e.g., the input 502a shown in FIG. 5). The LiDAR system 602 emits light 604a-c from a light emitter 606 (e.g., a laser transmitter). Light emitted by a LiDAR system is typically not in the visible spectrum; for example, infrared light is often used. Some of the light 604b emitted encounters a physical object 608 (e.g., a vehicle) and reflects back to the LiDAR system 602. (Light emitted from a LiDAR system typically does not penetrate physical objects, e.g., physical objects in solid form.) The LiDAR system 602 also has one or more light detectors 610, which detect the reflected light. In an embodiment, one or more data processing systems associated with the LiDAR system generates an image 612 representing the field of view 614 of the LiDAR system. The image 612 includes information that represents the boundaries 616 of a physical object 608. In this way, the image 612 is used to determine the boundaries 616 of one or more physical objects near an AV.

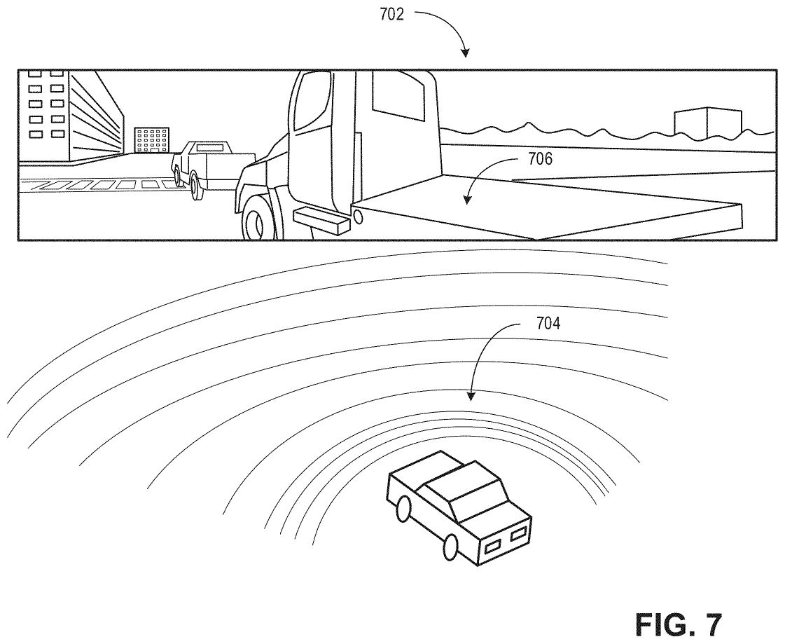

FIG. 7 shows the LiDAR system 602 in operation. In the scenario shown in this figure, the AV 100 receives both camera system output 504c in the form of an image 702 and LiDAR system output 504a in the form of LiDAR data points 704. In use, the data processing systems of the AV 100 compares the image 702 to the data points 704. In particular, a physical object 706 identified in the image 702 is also identified among the data points 704. In this way, the AV 100 perceives the boundaries of the physical object based on the contour and density of the data points 704.

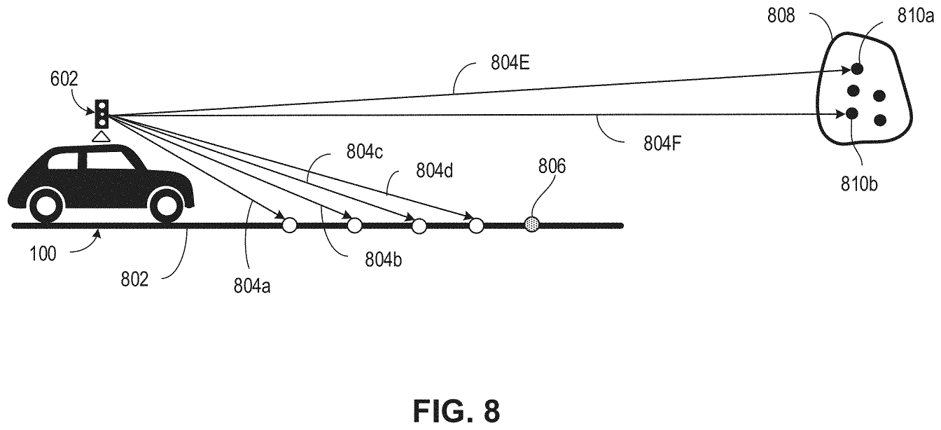

FIG. 8 shows the operation of the LiDAR system 602 in additional detail. As described above, the AV 100 detects the boundary of a physical object based on characteristics of the data points detected by the LiDAR system 602. As shown in FIG. 8, a flat object, such as the ground 802, will reflect light 804a-d emitted from a LiDAR system 602 in a consistent manner. Put another way, because the LiDAR system 602 emits light using consistent spacing, the ground 802 will reflect light back to the LiDAR system 602 with the same consistent spacing. As the AV 100 travels over the ground 802, the LiDAR system 602 will continue to detect light reflected by the next valid ground point 806 if nothing is obstructing the road. However, if an object 808 obstructs the road, light 804e-f emitted by the LiDAR system 602 will be reflected from points 810a-b in a manner inconsistent with the expected consistent manner. From this information, the AV 100 can determine that the object 808 is present.

### Path Planning

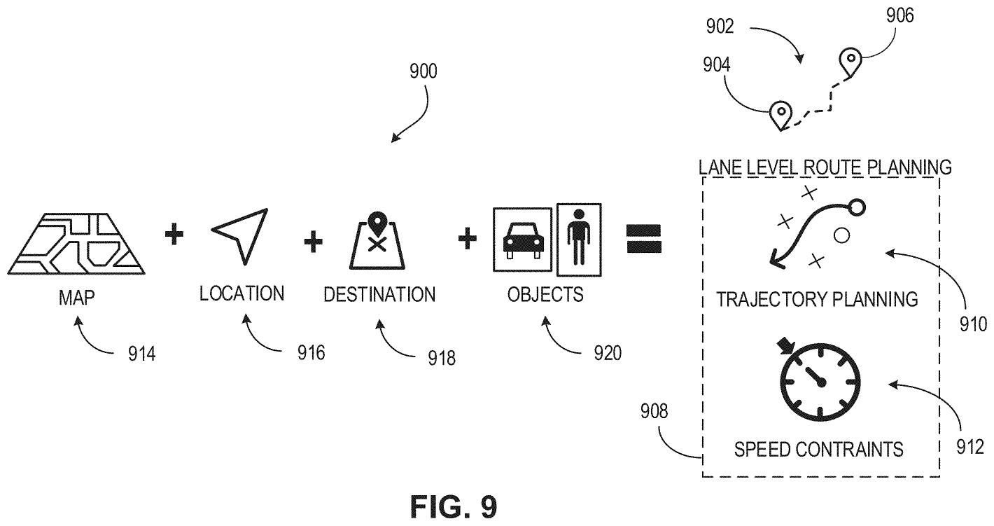

FIG. 9 shows a block diagram 900 of the relationships between inputs and outputs of a planning module 404 (e.g., as shown in FIG. 4). In general, the output of a planning module 404 is a route 902 from a start point 904 (e.g., source location or initial location), and an end point 906 (e.g., destination or final location). The route 902 is typically defined by one or more segments. For example, a segment is a distance to be traveled over at least a portion of a street, road, highway, driveway, or other physical area appropriate for automobile travel. In some examples, e.g., if the AV 100 is an off-road capable vehicle such as a four-wheel-drive (4WD) or all-wheel-drive (AWD) car, SUV, pick-up truck, or the like, the route 902 includes “off-road” segments such as unpaved paths or open fields.

In addition to the route 902, a planning module also outputs lane-level route planning data 908. The lane-level route planning data 908 is used to traverse segments of the route 902 based on conditions of the segment at a particular time. For example, if the route 902 includes a multi-lane highway, the lane-level route planning data 908 includes trajectory planning data 910 that the AV 100 can use to choose a lane among the multiple lanes, e.g., based on whether an exit is approaching, whether one or more of the lanes have other vehicles, or other factors that vary over the course of a few minutes or less. Similarly, in some implementations, the lane-level route planning data 908 includes speed constraints 912 specific to a segment of the route 902. For example, if the segment includes pedestrians or un-expected traffic, the speed constraints 912 may limit the AV 100 to a travel speed slower than an expected speed, e.g., a speed based on speed limit data for the segment.

In an embodiment, the inputs to the planning module 404 includes database data 914 (e.g., from the database module 410 shown in FIG. 4), current location data 916 (e.g., the AV position 418 shown in FIG. 4), destination data 918 (e.g., for the destination 412 shown in FIG. 4), and object data 920 (e.g., the classified objects 416 as perceived by the perception module 402 as shown in FIG. 4). In some embodiments, the database data 914 includes rules used in planning. Rules are specified using a formal language, e.g., using Boolean logic. In any given situation encountered by the AV 100, at least some of the rules will apply to the situation. A rule applies to a given situation if the rule has conditions that are met based on information available to the AV 100, e.g., information about the surrounding environment. Rules can have priority. For example, a rule that says, “if the road is a freeway, move to the leftmost lane” can have a lower priority than “if the exit is approaching within a mile, move to the rightmost lane.”

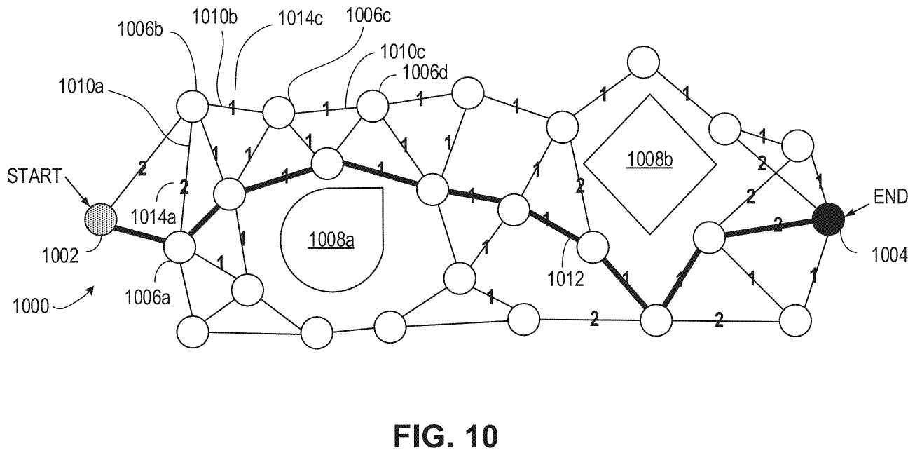

FIG. 10 shows a directed graph 1000 used in path planning, e.g., by the planning module 404 (FIG. 4). In general, a directed graph 1000 like the one shown in FIG. 10 is used to determine a path between any start point 1002 and end point 1004. In real-world terms, the distance separating the start point 1002 and end point 1004 may be relatively large (e.g., in two different metropolitan areas) or may be relatively small (e.g., two intersections abutting a city block or two lanes of a multi-lane road).

In an embodiment, the directed graph 1000 has nodes 1006a-d representing different locations between the start point 1002 and the end point 1004 that could be occupied by an AV 100. In some examples, e.g., when the start point 1002 and end point 1004 represent different metropolitan areas, the nodes 1006a-d represent segments of roads. In some examples, e.g., when the start point 1002 and the end point 1004 represent different locations on the same road, the nodes 1006a-d represent different positions on that road. In this way, the directed graph 1000 includes information at varying levels of granularity. In an embodiment, a directed graph having high granularity is also a subgraph of another directed graph having a larger scale. For example, a directed graph in which the start point 1002 and the end point 1004 are far away (e.g., many miles apart) has most of its information at a low granularity and is based on stored data, but also includes some high granularity information for the portion of the graph that represents physical locations in the field of view of the AV 100.

The nodes 1006a-d are distinct from objects 1008a-b which cannot overlap with a node. In an embodiment, when granularity is low, the objects 1008a-b represent regions that cannot be traversed by automobile, e.g., areas that have no streets or roads. When granularity is high, the objects 1008a-b represent physical objects in the field of view of the AV 100, e.g., other automobiles, pedestrians, or other entities with which the AV 100 cannot share physical space. In an embodiment, some or all of the objects 1008a-b are a static objects (e.g., an object that does not change position such as a street lamp or utility pole) or dynamic objects (e.g., an object that is capable of changing position such as a pedestrian or other car).

The nodes 1006a-d are connected by edges 1010a-c. If two nodes 1006a-b are connected by an edge 1010a, it is possible for an AV 100 to travel between one node 1006a and the other node 1006b, e.g., without having to travel to an intermediate node before arriving at the other node 1006b. (When we refer to an AV 100 traveling between nodes, we mean that the AV 100 travels between the two physical positions represented by the respective nodes.) The edges 1010a-c are often bidirectional, in the sense that an AV 100 travels from a first node to a second node, or from the second node to the first node. In an embodiment, edges 1010a-c are unidirectional, in the sense that an AV 100 can travel from a first node to a second node, however the AV 100 cannot travel from the second node to the first node. Edges 1010a-c are unidirectional when they represent, for example, one-way streets, individual lanes of a street, road, or highway, or other features that can only be traversed in one direction due to legal or physical constraints.

In an embodiment, the planning module 404 uses the directed graph 1000 to identify a path 1012 made up of nodes and edges between the start point 1002 and end point 1004.

An edge 1010a-c has an associated cost 1014a-b. The cost 1014a-b is a value that represents the resources that will be expended if the AV 100 chooses that edge. A typical resource is time. For example, if one edge 1010a represents a physical distance that is twice that as another edge 1010b, then the associated cost 1014a of the first edge 1010a may be twice the associated cost 1014b of the second edge 1010b. Other factors that affect time include expected traffic, number of intersections, speed limit, etc. Another typical resource is fuel economy. Two edges 1010a-b may represent the same physical distance, but one edge 1010a may require more fuel than another edge 1010b, e.g., because of road conditions, expected weather, etc.

When the planning module 404 identifies a path 1012 between the start point 1002 and end point 1004, the planning module 404 typically chooses a path optimized for cost, e.g., the path that has the least total cost when the individual costs of the edges are added together.

### Autonomous Vehicle Control

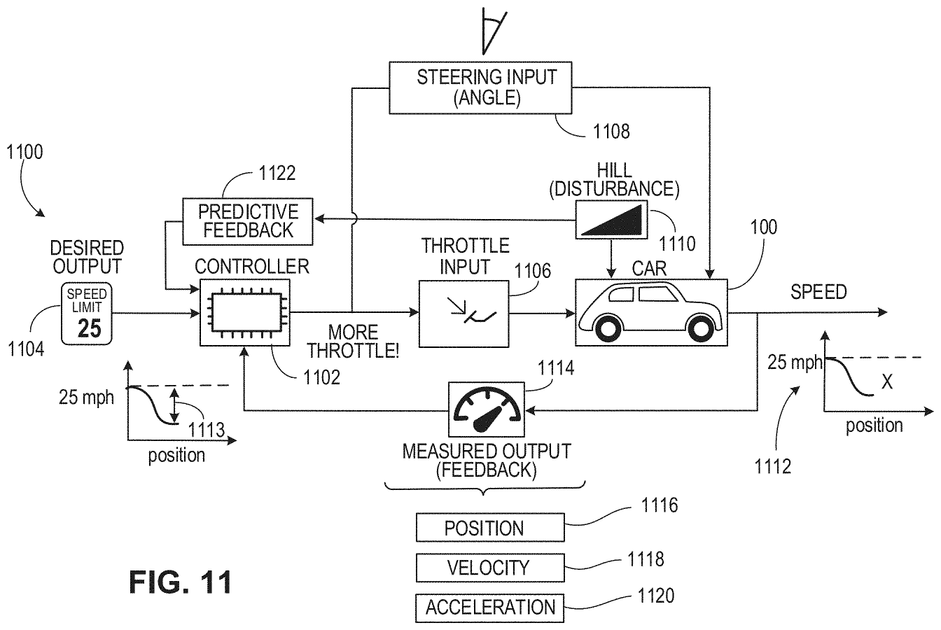

FIG. 11 shows a block diagram 1100 of the inputs and outputs of a control module 406 (e.g., as shown in FIG. 4). A control module operates in accordance with a controller 1102 which includes, for example, one or more processors (e.g., one or more computer processors such as microprocessors or microcontrollers or both) similar to processor 304, short-term and/or long-term data storage (e.g., memory random-access memory or flash memory or both) similar to main memory 306, ROM 308, and storage device 310, and instructions stored in memory that carry out operations of the controller 1102 when the instructions are executed (e.g., by the one or more processors).

In an embodiment, the controller 1102 receives data representing a desired output 1104. The desired output 1104 typically includes a velocity, e.g., a speed and a heading. The desired output 1104 can be based on, for example, data received from a planning module 404 (e.g., as shown in FIG. 4). In accordance with the desired output 1104, the controller 1102 produces data usable as a throttle input 1106 and a steering input 1108. The throttle input 1106 represents the magnitude in which to engage the throttle (e.g., acceleration control) of an AV 100, e.g., by engaging the steering pedal, or engaging another throttle control, to achieve the desired output 1104. In some examples, the throttle input 1106 also includes data usable to engage the brake (e.g., deceleration control) of the AV 100. The steering input 1108 represents a steering angle, e.g., the angle at which the steering control (e.g., steering wheel, steering angle actuator, or other functionality for controlling steering angle) of the AV should be positioned to achieve the desired output 1104.

In an embodiment, the controller 1102 receives feedback that is used in adjusting the inputs provided to the throttle and steering. For example, if the AV 100 encounters a disturbance 1110, such as a hill, the measured speed 1112 of the AV 100 is lowered below the desired output speed. In an embodiment, any measured output 1114 is provided to the controller 1102 so that the necessary adjustments are performed, e.g., based on the differential 1113 between the measured speed and desired output. The measured output 1114 includes measured position 1116, measured velocity 1118, (including speed and heading), measured acceleration 1120, and other outputs measurable by sensors of the AV 100.

In an embodiment, information about the disturbance 1110 is detected in advance, e.g., by a sensor such as a camera or LiDAR sensor, and provided to a predictive feedback module 1122. The predictive feedback module 1122 then provides information to the controller 1102 that the controller 1102 can use to adjust accordingly. For example, if the sensors of the AV 100 detect (“see”) a hill, this information can be used by the controller 1102 to prepare to engage the throttle at the appropriate time to avoid significant deceleration.

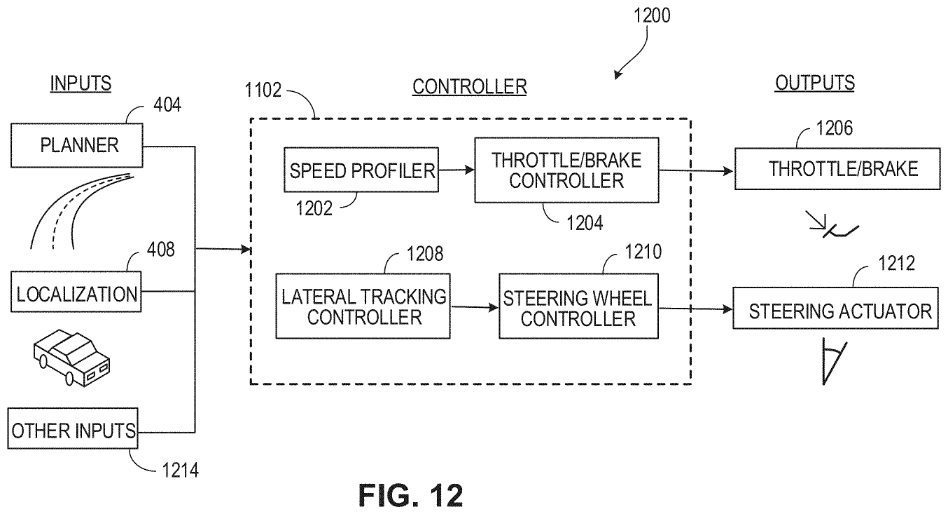

FIG. 12 shows a block diagram 1200 of the inputs, outputs, and components of the controller 1102. The controller 1102 has a speed profiler 1202 which affects the operation of a throttle/brake controller 1204. For example, the speed profiler 1202 instructs the throttle/brake controller 1204 to engage acceleration or engage deceleration using the throttle/brake 1206 depending on, e.g., feedback received by the controller 1102 and processed by the speed profiler 1202.

The controller 1102 also has a lateral tracking controller 1208 which affects the operation of a steering controller 1210. For example, the lateral tracking controller 1208 instructs the steering controller 1210 to adjust the position of the steering angle actuator 1212 depending on, e.g., feedback received by the controller 1102 and processed by the lateral tracking controller 1208.

The controller 1102 receives several inputs used to determine how to control the throttle/brake 1206 and steering angle actuator 1212. A planning module 404 provides information used by the controller 1102, for example, to choose a heading when the AV 100 begins operation and to determine which road segment to traverse when the AV 100 reaches an intersection. A localization module 408 provides information to the controller 1102 describing the current location of the AV 100, for example, so that the controller 1102 can determine if the AV 100 is at a location expected based on the manner in which the throttle/brake 1206 and steering angle actuator 1212 are being controlled. In an embodiment, the controller 1102 receives information from other inputs 1214, e.g., information received from databases, computer networks, etc.

### Predictive Analytics for Vehicle Health

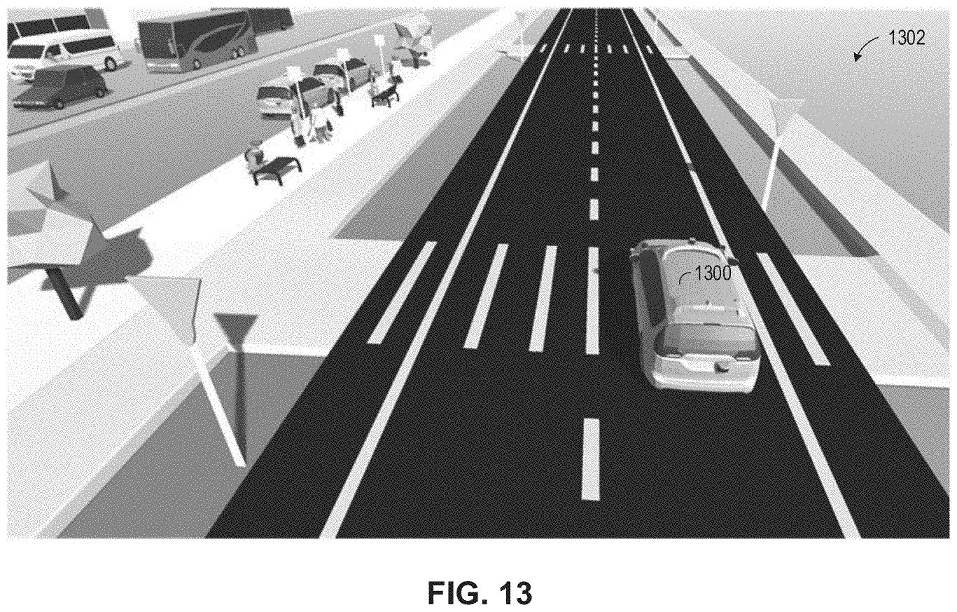

FIG. 13 shows a schematic diagram of a vehicle 1300 (e.g., the AV 100) in an environment 1302 (e.g., the environment 190). In general, as the vehicle 1300 operates within the environment 1302, the vehicle 1300 encounters various sources of wear and tear which cause the health of its components (e.g., electrical and mechanical components) to degrade. Each of these sources affect the health of different vehicle components, and to different extents. For example, utilization of the vehicle 1300, such as by driving or idling the vehicle, causes wear to the vehicle's engine and brakes, among other components. As another example, rough terrain in the environment 1302, including rapid slope changes, potholes, and unpaved roads, causes wear to the suspension and tires of the vehicle 1300. Other sources of wear and tear include, but are not limited to, atmospheric conditions within the environment 1302 (e.g., temperature, humidity, precipitation), impacts between the vehicle 1300 and objects within the environment 1302 (e.g., impacts with road debris, low hanging vegetation, airborne objects, curbs, etc.), internal utilization of the vehicle 1300 (e.g., depreciation of components in the cabin of the vehicle by the driver, passengers, or objects brought into the vehicle), and driving behavior by a human or computer-implemented driver of the vehicle 1300.

Over time, the various sources of wear and tear can cause components of the vehicle 1300 to degrade to a state of disrepair. At this point, the components need to be repaired or replaced to ensure safe vehicle operation and prevent further damage to the vehicle. To prevent components from degrading beyond their useful life, vehicle manufacturers offer maintenance schedules for components based on average or expected wear and tear. However, these maintenance schedules do not account for the wear and tear actually experienced by a particular vehicle or its components.

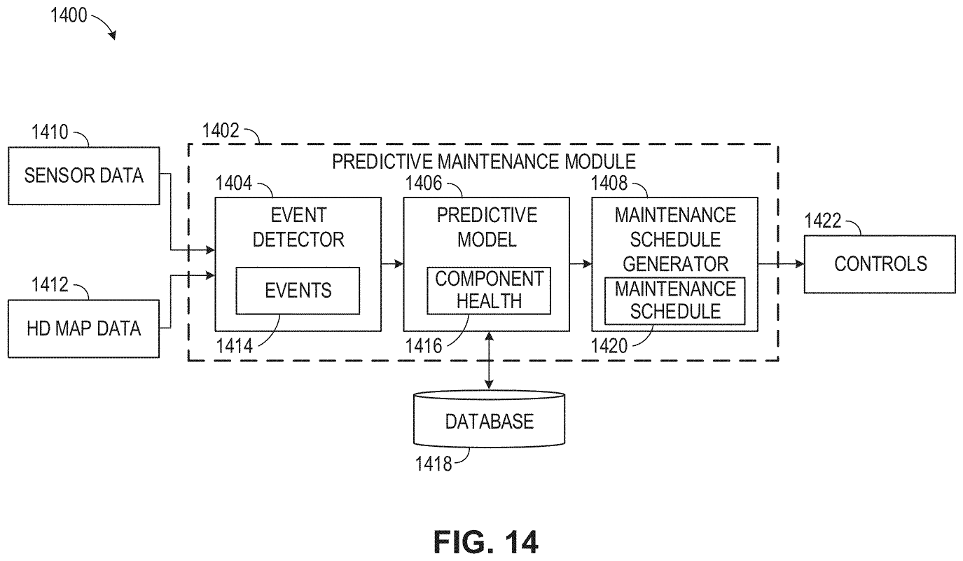

FIG. 14 shows a block diagram 1400 of the inputs, outputs, and components of a predictive maintenance module 1402. In general, the predictive maintenance module 1402 processes sensor data captured at a vehicle (e.g., the vehicle 1300) to detect events having a potential effect on the health of one or more components of the vehicle. The predictive maintenance module 1402 uses data associated with the detected events in conjunction with historical data for the vehicle or other vehicles (or both) to determine the health of some or all of the components of the vehicle. Based on the determined health information, the predictive maintenance module 1402 generates a predictive maintenance schedule representing predicted maintenance requirements for the vehicle. In an embodiment, the predictive maintenance schedule is provided to a control circuit of the vehicle, which navigates the vehicle to a maintenance center, safe stopping location, or other location in accordance with the predictive maintenance schedule or the health of the vehicle component, or both. In this manner, the predictive maintenance module 1402 improves vehicle safety and longevity while reducing unnecessary maintenance visits by personalizing vehicle maintenance based on the actual wear and tear experienced by the vehicle.

As shown in FIG. 14, the predictive maintenance module 1402 includes an event detector 1404 to detect events having a potential effect on one or more components of a vehicle, a predictive model 1406 to predict the health of the components of the vehicle based on data associated with the detected events, and a maintenance schedule generator 1408 to generate a maintenance schedule for the vehicle based on the predicted health of the vehicle components. The predictive maintenance module 1402 and its components (e.g., the event detector 1404, predictive model 1406, and maintenance schedule generator 1408) can be implemented by a vehicle system (e.g., the AV system 120), remote server(s) (e.g., the remote server 136), or a combination of them, among others. In an embodiment, the predictive maintenance module 1402 and its components are implemented by one or more processors (e.g., one or more computer processors such as microprocessors or microcontrollers or both) similar to processor 304, short-term and/or long-term data storage (e.g., memory random-access memory or flash memory or both) similar to main memory 306, ROM 308, and storage device 310, and instructions stored in memory that carry out operations of the respective component when the instructions are executed (e.g., by the one or more processors).

In operation, the event detector 1404 receives sensor data 1410 from one or more sensors (e.g., sensors 121) of the vehicle 1300. In general, the sensor data 1410 includes any measured or inferred information about the vehicle 1300 or its surrounding environment 1302. The event detector 1404 also receives high-definition (HD) map data 1412 for a portion of a road network traversed by the vehicle 1300. The HD map data 1410 includes high precision information about properties of the road network (e.g., geometry of the roadway, number of lanes, lane markers) and features along the road network (e.g., crosswalks, traffic signs, landmarks).

The event detector 1404 processes the sensor data 1410 and the HD map data 1412 to detect events 1414 experienced by the vehicle 1300 that have a potential effect on one or more vehicle components. In this context, the term “event” refers to an instance of wear and tear (or potential wear and tear) experienced by a vehicle from any source. The following description provides various examples of events 1414 that are detected by the event detector 1404. However, the following examples should not be construed as limiting, as the event detector 1404 can be configured to detect alternative or additional events in some embodiments.

In an embodiment, the event detector 1404 detects rough terrain events 1414. A rough terrain event 1414 includes an instance in which the vehicle 1300 hits a pothole, drives on an uneven or unpaved road, experiences rapid slope changes, drives over a speed bump, or otherwise experiences above average strain or stress due to physical features of the roadway. To detect rough terrain events 1414, the event detector 1404 processes the HD map data 1412 and/or sensor data 1410 from sensors such as an accelerometer, inertial measurement unit (IMU), or camera to visualize the rough terrain or detect impacts or vibrations indicative of the rough terrain. In an embodiment, the event detector 1404 uses the sensor data 1410 or the HD map data 1412, or both, to identify parameters for the rough terrain event 1414, such as a type of rough terrain (e.g., pothole, uneven road, unpaved road, rapid slope change, speed bump, etc.) and/or components of the vehicle potentially affected by the rough terrain (e.g., all wheels, front wheels, rear wheels, front-right wheel, etc.).

In an embodiment, the event detector 1404 detects low-acuity impact events 1414. A low-acuity impact event 1414 includes an instance in which the vehicle 1300 collides with road debris, low hanging vegetation, curbs, airborne objects (e.g., small rocks), or another object or feature of the roadway. In an embodiment, a low-acuity impact event 1414 includes only a minor impact with the vehicle 1300, such as an impact that imparts less than a threshold force on the vehicle such that the impact does not cause deployment of vehicle airbags or otherwise disable the vehicle. To detect low-acuity impact events 1414, the event detector 1404 processes the HD map data 1412 and/or sensor data 1410 from sensors such as an accelerometer, IMU, microphone, or camera, among others, to register minor impacts with objects. In an embodiment, the event detector 1404 uses the sensor data 1410 or the HD map data 1412, or both, to identify parameters for the low-acuity impact event 1414, such as a type of low-acuity impact (e.g., a type of object impacting the vehicle) and/or components of the vehicle potentially affected by the impact (e.g., windshield, undercarriage, portion of the vehicle body, wheel, etc.).

In an embodiment, the event detector 1404 detects atmospheric events 1414. An atmospheric event 1414 includes an instance in which there is precipitation, smoke, high or low temperature, high or low humidity, or other weather conditions in the environment 1302 that can affect the health of vehicle components. To detect atmospheric events 1414, the event detector 1404 processes sensor data 1410 from, for example, a precipitation sensor, a temperature sensor, a humidity sensor, or a camera, among others, to detect the atmospheric conditions within the environment surrounding the vehicle. In an embodiment, the event detector 1404 uses the sensor data 1410 to identify parameters for the atmospheric event 1414, such as a type of atmospheric event (e.g., type of precipitation, temperature, humidity, etc.) and/or a length or exposure level of such an event.

In an embodiment, the event detector 1404 detects internal depreciation events 1414. An internal depreciation event 1414 includes an instance in which a person or object within the vehicle 1300 causes wear and tear to the interior of the vehicle, such as food or drink being spilled within the vehicle, heavy objects moving within the vehicle, or passengers using or damaging the interior of the vehicle. To detect internal depreciation events 1414, the event detector 1404 processes sensor data 1410 from sensors such as internal microphones or cameras (with appropriate privacy protections) to identify instances of wear and tear to the interior of the vehicle. In an embodiment, the event detector 1404 uses the sensor data 1410 to identify parameters for the internal depreciation event 1414, such as a type of internal depreciation (e.g., spill, tear, shift of heavy object, etc.) and/or components of the vehicle potentially affected by the internal depreciation (e.g., floor, seat, dashboard, etc.).

In an embodiment, the event detector 1404 detects utilization events 1414. A utilization event 1414 includes an instance in which the vehicle 1300 is driven, idled, or otherwise used. To detect utilization events 1414, the event detector 1404 processes sensor data 1410 from sensors such as an accelerometer, IMU, or camera, among others, to detect use of the vehicle. In an embodiment, the event detector 1404 uses the sensor data 1410 to identify parameters for the utilization event, such as a type of utilization (e.g., driving, idling, battery/accessory mode, etc.) and/or a time, distance, or other length of utilization.

In an embodiment, the event detector 1404 detects driving events 1414. A driving event 1414 includes an instance in which a human or computer-implemented driver of the vehicle 1300 performs a maneuver that causes above-average strain or stress on the vehicle's components. To detect a driving event 1414, the event detector 1404 processes the HD map data 1412 and/or sensor data 1410 from sensors such as an accelerometer, IMU, or camera, among others, to visualize the driving event or detect inertial signatures characteristic of a driving event. In an embodiment, the event detector 1404 uses the sensor data 1410 or the HD map data 1412, or both, to identify parameters for the driving event 1414, such as a type of driving event (e.g., hard braking, hard acceleration, or swerving, among others).

After detecting one or more events 1414, the event detector 1404 provides data associated with each event 1414 to the predictive model 1406. In an embodiment, the data associated with an event 1414 includes raw or processed data (or both) from before, during, and/or after the event 1414. For example, the data associated with an event 1414 can include raw sensor data 1410 or HD map data 1412, or both, captured before, during, or after the event. As another example, the data associated with an event 1414 can include data produced by processing the sensor data 1410 or HD map data 1412, such as data indicating the event or parameters of the event, including a type of the event 1414 (e.g., a low-acuity impact event, a rough terrain event, a rough terrain event due to speed bumps, etc.), components potentially affected by the event 1414, or both, among other data.

The predictive model 1406 processes the data associated with the events 1414 to predict the health 1416 of some or all of the vehicle components. The term “health” refers to the extent of wear and tear on a vehicle component, with lower health being indicative of greater wear and tear to the vehicle component. In general, the predictive model 1406 uses predictive analytics, such as predictive modeling, machine learning, regressions, or combinations of them, among other statistical and analytical techniques, to predict the health 1416 of vehicle components. In an embodiment, the predictive model 1406 processes training data or other historical data that relates data associated with an event to the resultant effect on vehicle components in order to learn or otherwise establish a correlation between data associated with an event (or a combination of events) and its effect on the health of a vehicle component. The term “correlation” refers to any connection or relationship between data associated with an event and its effect on the health of a vehicle component, regardless of whether such a connection or relationship is expressly determined or impliedly used in predicting the health of the vehicle component. The predictive model 1406 can then process data associated with each event 1414 with the correlation information to predict the health 1416 of vehicle components.

In an embodiment, the predictive model 1406 is configured to learn or otherwise establish a correlation between data associated with each event 1414 (or combination of events) detected by the event detector 1404 and the resultant effect on the health of vehicle component(s). For example, the predictive model 1406 can determine that a rough terrain event 1414 correlates with increased wear on the tires, suspension, and drivetrain components of a vehicle, with rougher terrain (e.g., terrain imparting a greater force on the vehicle) correlating with greater wear. More specifically, the predictive model 1406 can determine that a particular type of rough terrain event 1414 (e.g., driving over a pothole with the front-right wheel) correlates with increased wear on, for example, the front-right tire, front-right suspension, and drivetrain components of the vehicle. Based on this correlation, the predictive model 1406 can predict the health 1416 of vehicle components, such as tires, suspension, or drivetrain components, from data associated with a rough terrain event 1414.

In an embodiment, the predictive model 1406 determines that a low-acuity impact event 1414 correlates with scratches, dents, or other damage to the impacted area, and predicts the health 1416 of vehicle components in the impacted area based on data associated with the low-acuity impact event 1414 and the correlation. In an embodiment, the predictive model 1406 determines that an atmospheric event 1414 correlates with, for example, water damage, rust accumulation, or decreased battery life, among other effects, depending on the type of atmospheric event. Based on this correlation, the predictive model 1406 can predict the health 1416 of vehicle components, such as the chassis, battery, or engine components, from data associated with an atmospheric event 1414. In an embodiment, the predictive model 1406 determines that an internal depreciation event 1414 correlates with tears, scratches, or other damage to the depreciated area, and predicts the health 1416 of vehicle components in the depreciated area based on data associated with the internal depreciation event 1414 and the correlation. In an embodiment, the predictive model 1406 determines that a utilization event 1414 correlates with wear to the engine, tires, transmission, and other components of a vehicle, with prolonged utilization correlating with greater wear. Based on this correlation, the predictive model 1406 can predict the health 1416 of vehicle components from data associated with the utilization event 1414. In an embodiment, the predictive model 1406 determines that a driving event 1414 correlates with increased wear to vehicle components depending on the type of driving event, with more aggressive driving behavior (e.g., hard acceleration, swerving, and hard braking, among others) causing greater wear to certain vehicle components. Based on this correlation, the predictive model 1406 can predict the health 1416 of vehicle components from data associated with the driving event 1414.

Using the correlation information, the predictive model 1406 predicts the health 1416 of vehicle components. For example, the predictive model 1406 accumulates data associated with events 1414 experienced by the vehicle over time and stores the data in a database 1418. At times, such as in response to the detection of an event 1414, a signal from the vehicle or a remote server, or another trigger, the predictive model 1406 processes the data associated with each event 1414 (or combination of events) with the correlation information to predict the health 1416 of vehicle components. In an embodiment, the predictive model 1406 processes data associated with an acute event 1414 along with the correlation to predict a change to the health 1416 of vehicle components caused by the acute event. The term “acute event” is used to refer to a single event experienced by a vehicle. In an embodiment, the predictive model 1406 processes data associated with multiple events 1414 experienced by the vehicle with the correlation information to predict an overall health 1416 of vehicle components. The data associated with the events 1414 or the predicted health 1416 of the vehicle components, or both, are stored in stored in the database 1418 so that the predicted health 1416 of vehicle components can be updated to account for future events 1414. In this manner, the predictive model 1406 predicts the cumulative effect of multiple events on the overall health 1416 of vehicle components.

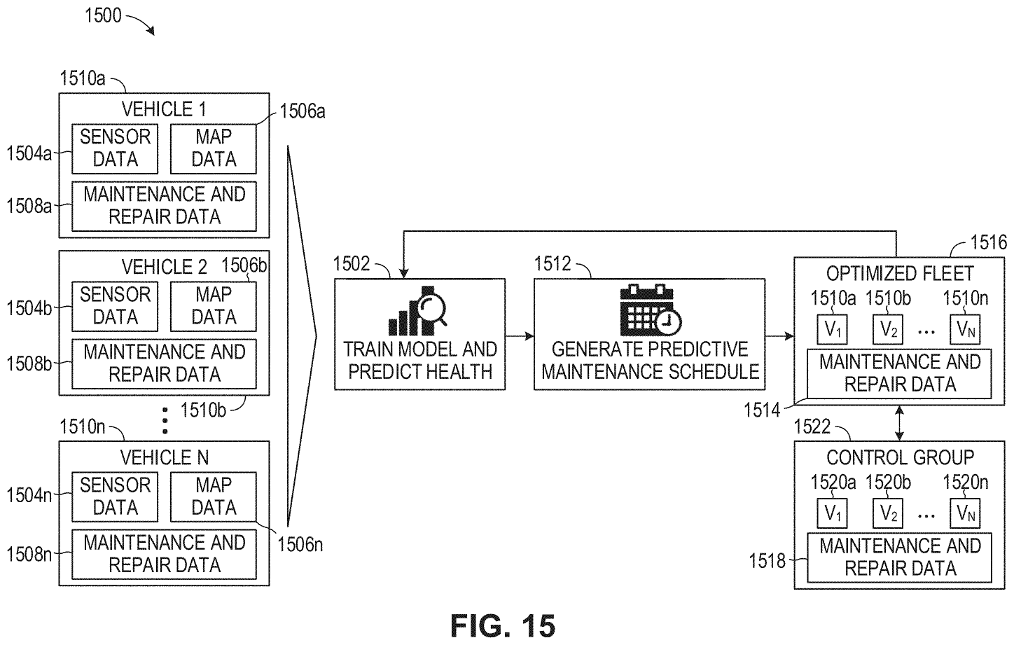

In general, the predictive model 1406 can express the health 1416 of a vehicle component in a variety of ways. In an embodiment, the health 1416 of a vehicle component is expressed relative to its total health (e.g., healthy, 75% health, etc.). In an embodiment, the health 1416 of a vehicle component is expressed as an expected time to failure (e.g., 100 miles to failure, 8 operating hours to failure, 44 rough terrain events until failure, etc.). In an embodiment, the health 1416 of a vehicle component is expressed in terms of whether it needs to be replaced (e.g., replacement needed, no replacement needed). Regardless of how the health 1416 of a vehicle component is expressed, the health 1416 can be represented by a numerical value or a nonnumeric descriptor. In an embodiment, the predictive model 1406 is configured to receive information about a replacement or repair of a vehicle component (e.g., from the vehicle, a user of the vehicle, a servicer of the vehicle, etc.), and can account for this information in subsequent predictions of the health 1416 of the vehicle component, as described below with reference to FIG. 15.

After predicting the health 1416 of some or all of the vehicle components, the predictive model 1406 provides the predicted health information to a maintenance schedule generator 1408. In general, the maintenance schedule generator 1408 processes the predicted health information to determine maintenance requirements and generate a maintenance schedule 1420 for the vehicle. In an embodiment, the maintenance schedule generator 1408 compares the predicted health 1416 of a vehicle component with one or more thresholds to determine whether the particular component needs to be replaced, repaired, or otherwise inspected by maintenance personnel or systems. In an embodiment, the thresholds used by the maintenance schedule generator 1408 are specific to the particular vehicle component, particular vehicle, or particular vehicle type (e.g., vehicle make, model, class, etc.), or combinations of them, among others. In an embodiment, each threshold is selected such that the component of the vehicle is still functioning when it is determined that the component needs to be replaced, repaired, or otherwise inspected in order to allow the vehicle to safely navigate to the maintenance center.

Using the determined maintenance requirements, the maintenance schedule generator 1408 causes the vehicle to navigate to a maintenance center or generates a maintenance schedule 1420 for the vehicle, or both. In an embodiment, the maintenance schedule 1420 specifies the vehicle components that need to be repaired, replaced, or otherwise inspected, and a recommended timeframe for such action. The maintenance schedule 1420 can also include an indication of the health 1416 of a vehicle component, among other information. In an embodiment, the maintenance schedule generator 1408 provides the maintenance schedule 1420 to a control module 1422 of the vehicle (e.g., the control module 406). The control module 1422 (alone or in combination with other components of the architecture 400) navigates the vehicle to a maintenance center or other location in accordance with the maintenance schedule 1420. For example, if the maintenance schedule 1420 indicates an immediate need to replace the vehicle's tires, the control module 1422 can cause the vehicle to navigate to an appropriate maintenance center for a tire change. As another example, if the maintenance schedule 1420 indicates that the vehicle's battery is due to be inspected within the next week, the control module 1422 can schedule a trip to an appropriate maintenance center on its own or in consultation with a user of the vehicle, a remote operator, or a representative of the maintenance center, among others. The control module 1422 can automatically navigate the vehicle to the maintenance center at the scheduled time. In an embodiment, the control module 1420 pulls the vehicle over or otherwise navigates the vehicle to a safe stopping area, for example, if it is determined that the vehicle needs to stop immediately to prevent damage to the vehicle or injury to its passengers.

In an embodiment, the maintenance schedule generator 1408 generates the maintenance schedule 1420 based on the predicted health information for multiple components. For example, if it is determined that the vehicle needs new tires in about 2,000 miles and a new battery in about 5,000 miles based on the information received from the predictive model 1406, the maintenance schedule generator 1408 can combine maintenance items in the generated maintenance schedule 1420 to keep the vehicle on the road longer. In an embodiment, the maintenance schedule generator 1408 considers information in addition to the predicted health information when generating the maintenance schedule, such as the severity of the repair (or severity of delaying the repair).

In an embodiment, the maintenance schedule 1420 is provided to other entities, such as a user of the vehicle, remote operator of the vehicle, maintenance personnel, or combinations of them, among others. For example, the maintenance schedule 1420 is displayed within the vehicle (e.g., using the display 312 or other computer peripherals 132 coupled to computing devices 146) for a user of the vehicle to view the maintenance schedule 1420. In an embodiment, the user of the vehicle can interact with the displayed maintenance schedule 1420 (e.g., using an input device 314) to select maintenance items and cause the vehicle to navigate to a maintenance center for repair of the selected items. The maintenance schedule 1420 can similarly be provided to computing devices remote from the vehicle for display and control of the vehicle to a maintenance center when safe to do so.

FIG. 15 illustrates a block diagram 1500 of the operation of a predictive maintenance module, such as the predictive maintenance module 1402 shown in FIG. 14. Initially, a predictive model 1502 (e.g., the predictive model 1406 in FIG. 14) receives sensor data 1504a, 1504b, . . . , 1504n (collectively sensor data 1504), HD map data 1506a, 1506b, . . . , 1506n (collectively map data 1506), maintenance and repair data 1508a, 1508b, . . . , 1508n (collectively maintenance and repair data 1508), and other training or historical data from multiple vehicles 1510a, 1510b, . . . , 1510n (collectively vehicles 1510). The predictive model 1502 processes the received data to learn or otherwise establish a correlation between the data and its effect on the health of a vehicle component. For example, if the maintenance and repair data 1508 for a vehicle 1510 shows that the vehicle's suspension was replaced, the predictive model 1502 can process the sensor data 1504 and HD map data 1506 prior to the suspension replacement to establish a correlation between the data and its effect on the vehicle's suspension. In an embodiment, the predictive model 1502 or a separate event detector (not shown) pre-processes the data received from the vehicles 1510 to identify events experienced by each vehicle, and the predictive model 1502 processes the pre-processed data to learn or otherwise establish a correlation between the data associated with an event and its effect on the health of a vehicle component.

Using the correlation information and the data received from the vehicles 1510, the predictive model 1502 predicts the health of the components of each vehicle 1510. A maintenance schedule generator 1512 (e.g., the maintenance schedule generator 1408 in FIG. 14) uses the predicted health information to generate a predictive maintenance schedule for each vehicle 1510. In an embodiment, the predictive maintenance schedule is provided to a control module of the respective vehicle 1510 to navigate the vehicle to a maintenance center or other location in accordance with the maintenance schedule. After the vehicle is serviced, maintenance and repair data 1514 is provided back to the predictive model 1502 to retrain or otherwise improve the correlation between data associated with an event experienced by the vehicle and its effect on the health of a vehicle component. The predictive model 1502 also uses the maintenance and repair data 1514 to account for repairs to vehicle components in subsequent predictions. Over time, the vehicles 1510 serviced in accordance with the predictive maintenance schedules become part of an optimized fleet 1516 of vehicles maintained based on the actual wear and tear each vehicle experiences. In an embodiment, maintenance and repair data 1514 for vehicles 1510 in the optimized fleet 1516 are compared with maintenance and repair data 1518 for vehicles 1520a, 1520b, . . . , 1520n (collectively vehicles 1520) in a control group 1522 that are serviced in accordance with, for example, maintenance schedules provided by vehicle manufacturers or other maintenance schedules. In this manner, metrics such as the cost of ownership and useful life of vehicles 1510 in the optimized fleet 1516 can be compared with those of the vehicles 1520 in the control group 1522.

The predictive techniques described here have applications beyond generating a predictive maintenance schedule for a vehicle. In an embodiment, information received from vehicles (e.g., sensor data, HD map data, etc.) and the correlations established by the predictive model (e.g., the predictive model 1406) are used in reverse to identify geographical areas causing an outsized impact on vehicle maintenance. In an embodiment, this information is used for risk-based routing, such as by selecting a route for a vehicle that minimizes the impact on the health of vehicle components, or prioritizing which vehicles in a fleet are sent to high impact areas based on the vehicle's health. For example, if an area of a city is known to have rough roads which cause deterioration, a route can be selected for the vehicle to avoid the rough roads, or a fleet operator could prioritize sending vehicles that are past their useful life to travel on the rough roads (or vehicles having components that are healthy such that the vehicles can withstand the rough roads). In an embodiment, information about areas causing an outsized impact on vehicle maintenance are used to generate an infrastructure report identifying roads or other infrastructure that need repair or maintenance. The infrastructure report can be provided to, for example, government officials to assist in prioritizing infrastructure improvements.

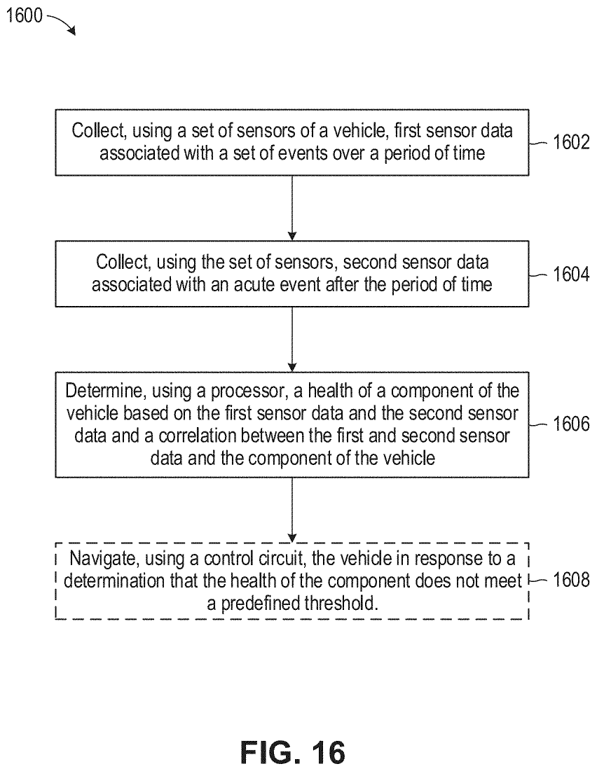

FIG. 16 shows a flowchart of an example process 1600 for predicting maintenance requirements of a vehicle. In an embodiment, the vehicle is the AV 100 shown in FIG. 1, and the process 1600 is carried out by a processor of the vehicle or a remote computer system in communication with the vehicle, such as the processor 304 shown in FIG. 3.

The processor collects 1602, using a set of sensors of a vehicle, first sensor data associated with a set of events over a period of time. The processor also collects 1604, using the set of sensors, second sensor data associated with an acute event (e.g., a single event experienced by the vehicle) after the period of time. In an embodiment, the set of sensors of the vehicle (e.g., the sensors 121) include at least one of a camera, microphone, IMU, LiDAR, RADAR, or GPS. In an embodiment, at least one of the events are identified based at least in part on HD map data alone or in combination with the sensor data. In an embodiment, the events and the acute event include at least one of a rough terrain event, low acuity impact event, atmospheric condition event, internal depreciation event, utilization event, or driving event, among others. In an embodiment, the sensor data is processed to identify parameters for an event, such as a type of event or the vehicle components potentially affected by the event, or both. For example, the sensor data or the HD map data, or both, are used to identify parameters such as a type of rough terrain (e.g., pothole, uneven road, unpaved road, rapid slope change, speed bump, etc.) and components of the vehicle potentially affected by the rough terrain (e.g., all wheels, front wheels, rear wheels, front-right wheel, etc.) for a rough terrain event.

The processor determines 1606 a health of a component of the vehicle based on the first sensor data and the second sensor data and a correlation between the first and second sensor data and the component of the vehicle. In an embodiment, determining the health of the component of the vehicle includes processing each of the first sensor data associated with the set of events (or the events or parameters of the events) and the second sensor data associated with the acute event (or the acute event or parameters of the acute event) with a predictive model. The predictive model is configured to apply the correlation to the first and second sensor data to determine the health of the component of the vehicle. In an embodiment, the correlation includes a learned or known relationship between data associated with a particular event (or combination of events) and the corresponding effect on the health of a vehicle component. In an embodiment, the correlation is specific to the vehicle or the vehicle type (e.g., vehicle make, model, class, etc.). In an embodiment, the correlation is retrained or otherwise improved over time using event data, maintenance and repair data, or other training data. For example, information regarding maintenance to the vehicle component is received by the processor, and the correlation is adjusted by the processor based at least in part on the first and second sensor data and the information regarding the maintenance to the vehicle component.

In an embodiment, the component of the vehicle includes any electrical or mechanical component of the vehicle, including the set of sensors. In an embodiment, the first sensor data related to the set of events over the period of time is transmitted to a remote computer system in response to collecting the first sensor data, and determining the health of the component of the vehicle includes transmitting the second sensor data associated with the acute event to the remote computer system, and receiving an indication of the health of the component from the remote computer system.

The processor navigates 1608 the vehicle using a control circuit in response to a determination that the health of the component does not meet a predefined threshold. In an embodiment, this step is optional, as shown by the dashed line in FIG. 16. In an embodiment, the processor causes the vehicle to navigate to a maintenance center, to a safe stopping location, or another location using the control circuit of the vehicle in response to the determination that the health of the vehicle component does not satisfy a predefined threshold. In an embodiment, the predefined threshold is selected such that the component of the vehicle is still functioning when the vehicle is navigated to the maintenance center, stopping location, or other location. In an embodiment, navigating the vehicle includes causing, by the control circuit, the vehicle to self-drive and self-navigate to the maintenance center. In an embodiment, a maintenance schedule for the vehicle is generated based on the health of the component. In an embodiment, a route along a road network for the vehicle is determined based at least in part on the health of the component.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A computer-implemented method, comprising:
collecting, using a set of sensors of a vehicle, first sensor data associated with a set of events over a period of time;
collecting, using the set of sensors, second sensor data associated with an acute event after the period of time;
determining, using a processor, a health of a component of the vehicle based on the first sensor data and the second sensor data and a correlation between the first and second sensor data and the component of the vehicle; and
navigating, using a control circuit, the vehicle in response to a determination that the health of the component does not meet a predefined threshold.

2. The method of claim 1, wherein determining the health of the component of the vehicle includes processing each of the first sensor data associated with the set of events and the second sensor data associated with the acute event with a predictive model.

3. The method of claim 1, wherein the predictive model is configured to apply the correlation to the first and second sensor data to determine the health of the component of the vehicle.

4. The method of claim 1, comprising:
receiving information regarding maintenance to the vehicle component; and
adjusting, by the processor, the correlation based at least in part on the first and second sensor data and the information regarding the maintenance.

5. The method of claim 1, wherein the events include at least one of a rough terrain event, a low acuity impact event, an atmospheric event, or an internal depreciation event.

6. The method of claim 1, wherein each of the events include at least one parameter identified based on the first sensor data.

7. The method of claim 1, wherein at least one of the events is identified based at least in part on high-definition map data.

8. The method of claim 1, wherein the component of the vehicle includes a sensor from the set of sensors.

9. The method of claim 1, comprising, in response to collecting the first sensor data related to the set of events over the period of time, transmitting the first sensor data to a remote computer system; and
wherein determining the health of the component of the vehicle includes:
transmitting the second sensor data associated with the acute event to the remote computer system, and
receiving an indication of the health of the component from the remote computer system.

10. The method of claim 1, comprising generating a maintenance schedule for the vehicle based on the health of the component.

11. The method of claim 1, wherein navigating the vehicle includes navigating the vehicle to a maintenance center based on determining that the health of the component does not meet the predefined threshold.

12. The method of claim 1, wherein navigating the vehicle includes navigating the vehicle to a stopping location based on determining that the health of the component does not meet the predefined threshold.

13. The method of claim 2, wherein the predefined threshold is selected such that the component of the vehicle is still functioning when the vehicle is navigated.

14. The method of claim 1, wherein navigating the vehicle includes causing, by the control circuit, the vehicle to self-drive and self-navigate.

15. The method of claim 1, comprising determining a route along a road network for the vehicle based at least in part on the health of the component.

16. The method of claim 1, wherein the method is performed by at least one processor of the vehicle.

17. The method of claim 1, wherein the method is performed by a remote computer system in communication with the vehicle.

18. A vehicle, comprising:
a computer-readable media storing computer-executable instructions; and
a processor communicatively coupled to the computer-readable media, the processor configured to execute the computer executable instructions to perform operations including:
identifying events experienced by a vehicle over a particular time period, the events being identified based at least in part on sensor data from a set of sensors at the vehicle;
identifying an acute event experienced by a vehicle after the particular time period, the acute event being identified based at least in part on sensor data from the set of sensors at the vehicle;
determining a health of a component of the vehicle based on the first sensor data and the second sensor data and a correlation between the first and second sensor data and the component of the vehicle; and
navigating, using a control circuit, the vehicle in response to a determination that the health of the component does not meet a predefined threshold.

19. A non-transitory computer-readable storage medium comprising one or more programs for execution by one or more processors of a device, the one or more programs including instructions which, when executed by the one or more processors, cause the device to perform operations including:
identifying events experienced by a vehicle over a particular time period, the events being identified based at least in part on sensor data from a set of sensors at the vehicle;
identifying an acute event experienced by a vehicle after the particular time period, the acute event being identified based at least in part on sensor data from the set of sensors at the vehicle;
determining a health of a component of the vehicle based on the first sensor data and the second sensor data and a correlation between the first and second sensor data and the component of the vehicle; and
navigating, using a control circuit, the vehicle in response to a determination that the health of the component does not meet a predefined threshold.
